(19) United States
(12) Patent Application Publication
(10) Pub. No.: US 2010/0227549 A1
(43) Pub. Date: Sep. 9, 2010

(54) Apparatus and Method for Pairing Bluetooth Devices by Acoustic Pin Transfer

(76) Inventor: Alan Kozlay, Belcamp, MD (US)

Correspondence Address: NIXON & VANDERHYE, PC, 901 NORTH GLEBE ROAD, 11TH FLOOR, ARLINGTON, VA, 22203, US

(21) Appl. No.: 12/716,530

(22) Filed: Mar. 3, 2010

Related U.S. Application Data
(60) Provisional application No. 61/157,327, filed on Mar. 4, 2009.

(51) Int. Cl. H04L 9/00

(52) U.S. Cl. 455/26.1

(57) ABSTRACT

A simplified apparatus and method for securely pairing Bluetooth™ and similar radio audio devices by transmitting a PIN value encoded as a tone from ear bud or speaker of one device and the microphone of the other. This apparatus and method do not require an implementation of the “Simple Secure Pairing” feature on both devices nor do they require the display and operator acceptance of verification values, tones, or computed numeric values.

### CROSS-REFERENCES TO RELATED APPLICATIONS

This application claims the benefit of U.S. Provisional Patent Application Ser. No. 61/157,327, filed Mar. 4, 2009, the entire content of which is herein incorporated by reference.

### STATEMENT REGARDING FEDERALLY SPONSORED RESEARCH OR DEVELOPMENT

(NOT APPLICABLE)

### BACKGROUND OF THE INVENTION

The invention relates to wireless communications and, more particularly, to the security of Bluetooth™ and other Personal Area Network (PAN) audio devices.

Many electronic devices are capable of wireless communication between one another via a communication standard. An exemplary communication standard is known as Bluetooth™, which is an open wireless protocol for exchanging data over short distances (using short length radio waves) from fixed and mobile devices, creating personal area networks (PANs). Bluetooth™ devices may be paired by introducing or exchanging shared information that enables the devices to trust each other prior to the establishment of Bluetooth™ radio communications. Many Bluetooth™ devices are paired by introducing a common PIN into both devices prior to pairing over a radio link. This PIN may be short to reduce the occurrence of user error while entering the PIN. Some Bluetooth™ devices have a fixed PIN that must be matched by the other device. These operations require the operator to accept that the pairing appears to have been performed between the correct devices. This method of pairing can be insecure if the PIN is short or is simply a constant number for many devices. In addition, some devices, such as a Bluetooth™ headset or ear-bud have limited or no display capability. In this case, it is difficult to enter or display a PIN number, thereby defeating the security value of the PIN.

Recently, the Bluetooth™ standards group has developed a 2.1 specification for a Secure Simple Pairing (SSP) feature that calls for the Bluetooth™ devices, which support the new feature, to generate and exchange a pseudo-random verification value to both devices. On devices with displays, the user can examine the values presented by both devices and decide to move forward in the pairing process if the verification values are the same. This technique is not foolproof, however, because it could perform pairing with a third device in the vicinity, instead of the intended device, or relay the pairing through a man-in-the-middle. This problem is especially acute with devices that have little or no display capability for the operator to check the pairing verification values. Of course, Secure Simple Pairing is not possible when the pairing is to be made with legacy equipment that does not support the Secure Simple Pairing feature.

Therefore, there is a need in the industry for an apparatus and method to perform pairing with a PIN in a secure way in the absence of a display and/or keyboard, or the absence of the Secure Simple Pairing feature, or without the user having to input data or operate controls.

In U.S. Published Patent Application No. 2008/0268776 to Amendola, a method and apparatus for secure pairing of Bluetooth™ devices is discussed in which a method and apparatus for verifying that the Verification Value generated as part of the Secure Simple Pairing procedure option of Bluetooth™ V2.1 standard has taken place and uses tones exchanged between the two devices to indicate that the verification values of the two devices match. This application specifically addresses the problem of preventing a man-in-the-middle attack on the Bluetooth™ Secure Simple Pairing option in which the first part of Secure Simple Pairing has been performed via a Bluetooth™ radio link, after which the operator accepts or rejects the pairing based on a verification value displayed on each device. Note that the Secure Simple Pairing radio communication and cryptographic process has taken place before this acoustic check is made, and the Amendola patent addresses the acceptance or rejection of the resulting Verification Values before completing the remaining portion of the pairing process.

Kohlenberg et al. in U.S. Published Patent Application No. 2008/0162937 teaches the transmission of strong encryption keys by out-of-band transmission channels such as acoustic signaling. This application describes the transmission of cryptographic keys by this method, not the exchange of PINs to authenticate the identity of the paired devices.

Julian et al. in U.S. Published Patent Application No. 2009/0034591, Method of Pairing Devices, describes determinations that a device is discoverable and pairable as well as the pairing response are performed by radio links.

Vauclair, in U.S. Published Patent Application No. 2008/0320587, Secure Pairing for Wired or Wireless Communications Devices, describes a pairing system that uses Near Field Radio Communication to pair devices that are in a vicinity within which such radio signals can be detected.

### BRIEF SUMMARY OF THE INVENTION

It would be desirable to provide a method for sharing a Bluetooth™ PIN between Bluetooth™ devices that share audio generation and reception in advance of Bluetooth™ pairing. The PIN transfer may be performed between devices in the absence or limited extent of display and/or button control features on one or both devices.

It would be further desirable to provide an apparatus and method for acoustically transmitting and receiving a PIN that is longer and therefore potentially more secure than would be convenient for the user to manually enter with limited entry means.

The pairing procedure of the described embodiments works with all Bluetooth™ devices, including those that do not support the Secure Simple Pairing Feature.

In an exemplary embodiment, a method of wirelessly pairing electronic devices includes the steps of a first electronic device randomly generating a PIN for wireless connection with a second electronic device; converting the randomly generated PIN into acoustical tones; the first electronic device generating the acoustical tones in a vicinity of the second electronic device; the second electronic device receiving and decoding the acoustical tones; and pairing the first and second electronic devices. The pairing step may be practiced by the first electronic device initiating a pairing process based on the generated and received acoustical tones or by the second electronic device initiating the pairing process based on the generated and received acoustical tones. The pairing step may be practiced according to a communication standard, wherein a length of the randomly generated PIN is equal to a maximum length permitted by the communication standard.

In another exemplary embodiment, an apparatus for pairing audio devices includes structure configured for randomly generating a PIN, and structure configured for exchanging the randomly generated PIN between the audio devices via an audio link. In this context, at least one of the audio devices may include an audio speaker, and at least another of the audio devices may include an audio microphone. The exchanging structure may include structure for outputting acoustical tones corresponding to the randomly generated PIN via the audio speaker, and structure for receiving and decoding the acoustical tones via the audio microphone. The structure for randomly generating the PIN and the means for exchanging the randomly generated PIN may comprise software programmed on at least one of the audio devices.

In yet another exemplary embodiment, a method of pairing audio devices includes the steps of randomly generating a PIN; and exchanging the randomly generated PIN between the audio devices via an audio link. In this context, with at least one of the audio devices including an audio speaker, and with at least another of the audio devices including an audio microphone, the exchanging step may comprise outputting acoustical tones corresponding to the randomly generated PIN via the audio speaker, and receiving and decoding the acoustical tones via the audio microphone. Prior to the exchanging step, the method may include placing the at least another audio device with the audio microphone in a vicinity of the at least one audio device with the audio speaker.

In still another exemplary embodiment, an electronic device capable of wireless pairing with another electronic device includes a processor that randomly generates a PIN for wireless connection with another electronic device, and a pairing circuit communicating with the processor. The pairing circuit includes a coding sub-circuit that converts the randomly generated PIN into acoustical tones. A speaker output communicating with the processor and the pairing circuit generates the acoustical tones when it is desired to wirelessly pair the electronic device with another electronic device. The pairing circuit may additional include a decoding sub-circuit that receives and decodes acoustical tones generated by another electronic device. In one embodiment, the electronic device has no display and/or no keyboard. Preferably, pairing is performed according to a communication standard, wherein the processor is programmed to generate the randomly generated PIN having a length equal to a maximum length permitted by the communication standard.

### BRIEF DESCRIPTION OF THE DRAWINGS

These and other aspects and advantages will be described in detail with reference to the accompanying drawings, in which:

FIG. 1 shows an audio link and Bluetooth™ radio communications paths between two electronic devices;

FIG. 2 shows an exemplary cell phone to be paired with a headset and an impostor headset which is out of audio range; and

FIG. 3 is a pairing flow diagram.

### DETAILED DESCRIPTION OF THE INVENTION

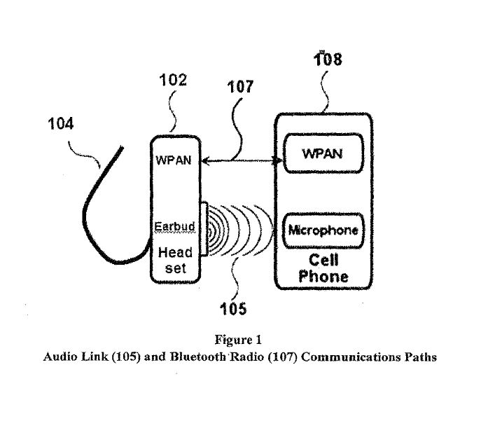

FIG. 1 illustrates an exemplary embodiment of the present invention which presents a set of two Bluetooth™-equipped audio devices, including a cell phone or handheld Personal Digital Assistant (PDA) 108 and an ear-mounted headset 102 with ear retaining clip 104. In order to implement Bluetooth™, it is assumed that the devices contain a processor and memory. In this example, a headset 102 is both acoustically-coupled with PDA 108 and also communicates with the same PDA using a Bluetooth™ radio link. In this example, a PIN is pseudo-randomly generated in the headset and converted to corresponding acoustical tones. The acoustical tones emanate from the speaker of the headset and are received and decoded into PIN data in the PDA. Once the PIN has been transmitted, the Bluetooth™ pairing process and subsequent Bluetooth™ communications can take place. Note that the PIN generation and acoustical coupling may originate from either device.

When Bluetooth™ devices are to be paired following the standard procedure, a button or sequence of button activations is commonly used to signal to each device that the user intends to begin the pairing process. As illustrated in the drawings, either of the Bluetooth™ devices 102 or 108 is capable of producing a set of tones or a pulsed tone 105 that can be used to encode the PIN or Passkey. This pairing process preferably begins by placing the Bluetooth™ devices in close proximity so that the microphone of the audio receiving device can “hear” the audio signal of the speaker of the sending device, and the PIN can be recovered by the receiving device to establish a common PIN prior to Bluetooth™ pairing. The Bluetooth™ pairing procedure is only possible in accordance with the standard if the PINs or Passkeys match. Note that the acoustic transfer of the PIN occurs before any radio-based pairing or other radio communications activity 107. Note also that the PIN may be pseudo-randomly generated to the maximum length provided for in the Bluetooth™ standard without increasing the difficulty of pairing. Depending upon the implementation, the PIN may or may not be displayed on the PDA. In the latter case, security may be enhanced because there is no human knowledge of the key.

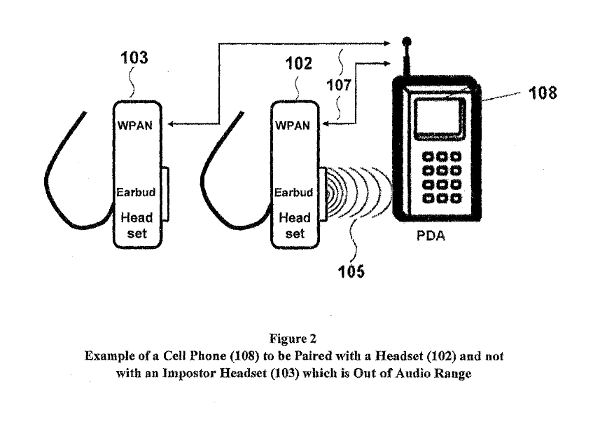

FIG. 2 is a diagram describing the acoustic and Bluetooth™ radio communications paths in the presence of a third device. The third headset is in Bluetooth™ radio range, but not in acoustical coupling range. In this case, an undesired pairing may take place if the devices are not using unique PINs to authenticate each other. In this example, PDA 108 will be in immediate proximity to headset 102 so that it can acoustically send a presumed-unique pseudo-random PIN with headset 102. Headset 103 is a third-party headset that is out of hearing of the PDA earpiece and cannot receive the PIN that was sent. When standard Bluetooth™ pairing is executed, the code executing the pairing procedure will depend upon the existence of identical PINs in both devices to complete the pairing process. Therefore, only the pair consisting of PDA 108 and headset 102 will contain an identical PIN and be successfully paired. Headset 103 will not be able to become paired.

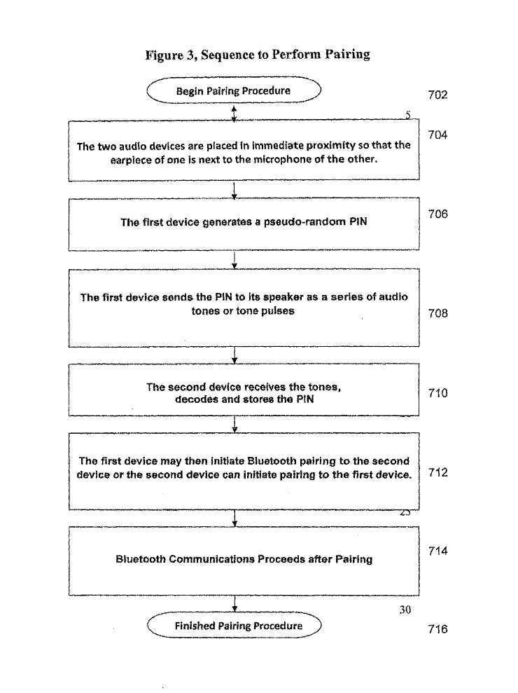

FIG. 3 is a flow diagram that describes an example of a Bluetooth™ pairing procedure using acoustic coupling to transfer a pseudo-random PIN between devices before carrying out the process of Bluetooth™ pairing. The pairing procedure is begun in step 702. The audio devices are placed in immediate proximity to one another so that the speaker output of one is next to the microphone of the other (step 704). The first device generates a pseudo-random PIN (step 706), and the first device sends the PIN to its speaker as a series of audio tones or tone pulses (step 708). The second device receives the tones and decodes and processes the PIN (step 710). The first device may then initiate Bluetooth™ pairing to the second device, or the second device can initiate pairing to the first device (step 712). Bluetooth™ communication proceeds after pairing (step 714), and the pairing procedure is complete (step 716).

The audio coupling may be performed by a variety of data transmission techniques that are well known to the art, including acoustic modem technology, to both encode the PIN data as a series of tones to be sent and decode the PIN data from the received tones. A simple software-only implementation, for example, can be constructed by the software generation and detection of two wavelengths, one to represent a “1” bit and another to represent a “0” bit. Because the amount of data is small, the encoding scheme does not have to be efficient to accomplish the purpose of PIN transfer between devices.

In contrast with the above-noted Amendola application, the described embodiments do not require the Secure Simple Pairing option but instead use the PIN option that is available for all versions of the Bluetooth™ standard. This simpler approach transmits the PIN code from one device to the other (in either direction) to establish a common PIN in each device as a basis for beginning a pairing process. This is different from the Amendola invention in at least three ways: (1) the described embodiments transfer the acoustic information between devices at a different time (at the beginning of the pairing process), (2) they exchange a PIN instead of a Verification Value, and (3) they do it for a different purpose (to establish a PIN on both sides instead of checking the result of a prior radio-based Secure Simple Pairing operation).

In contrast with the Kohlenberg application, the described embodiments only transmit a PIN or Passkey that is used to ensure the identity of the paired units. Encryption keys or other cryptographic variables are created and securely exchanged by means of standard Bluetooth™ radio protocols once the identity of the devices has been established by the possession of a common PIN per the existing and publically available Bluetooth™ standards.

Conventionally, Bluetooth™ pairing starts with one device (such as a headset) becoming “Discoverable” to the other device (such as a phone) so that it (the phone) can ascertain the Bluetooth™ address of the other (the headset). With an address to send a pairing request too, the phone can initiate the pairing. As a practical example, with the structure of the described embodiments, after audio transfer of pairing data, one of the Bluetooth™ devices will initiate pairing to the other. In practice, it will preferably be the phone initiating but it could be either. In one implementation of the invention, the audio exchange of the PIN is followed by having the device that receives the Bluetooth™ pairing request (e.g., headset) send its Bluetooth™ address to the phone over audio as well. While this is not required, it gives the additional benefit of not needing to make the headset discoverable before Bluetooth™ pairing takes place. Thus, in this example, the headset is “connectable” but not “discoverable,” which is advantageous.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A method of wirelessly pairing electronic devices, the method comprising:
a first electronic device randomly generating a PIN for wireless connection with a second electronic device;
converting the randomly generated PIN into acoustical tones;
the first electronic device generating the acoustical tones in a vicinity of the second electronic device;
the second electronic device receiving and decoding the acoustical tones; and
pairing the first and second electronic devices.

2. A method according to claim 1, wherein the pairing step is practiced by the first electronic device initiating a pairing process based on the generated and received acoustical tones.

3. A method according to claim 1, wherein the pairing step is practiced by the second electronic device initiating a pairing process based on the generated and received acoustical tones.

4. A method according to claim 1, wherein the pairing step is practiced according to a communication standard, and wherein a length of the randomly generated PIN is equal to a maximum length permitted by the communication standard.

5. An apparatus for pairing audio devices, the apparatus comprising means for randomly generating a PIN, and means for exchanging the randomly generated PIN between the audio devices via an audio link.

6. An apparatus according to claim 5, wherein at least one of the audio devices includes an audio speaker, and wherein at least another of the audio devices includes an audio microphone, the means for exchanging the randomly generated PIN comprising means for outputting acoustical tones corresponding to the randomly generated PIN via the audio speaker, and means for receiving and decoding the acoustical tones via the audio microphone.

7. An apparatus according to claim 6, wherein the means for randomly generating the PIN and the means for exchanging the randomly generated PIN comprise software programmed on at least one of the audio devices.

8. A method of pairing audio devices, the method comprising:
randomly generating a PIN; and
exchanging the randomly generated PIN between the audio devices via an audio link.

9. A method according to claim 8, wherein at least one of the audio devices includes an audio speaker, and wherein at least another of the audio devices includes an audio microphone, the exchanging step comprising outputting acoustical tones corresponding to the randomly generated PIN via the audio speaker, and receiving and decoding the acoustical tones via the audio microphone.

10. A method according to claim 9, wherein prior to the exchanging step, the method comprises placing the at least another audio device with the audio microphone in a vicinity of the at least one audio device with the audio speaker.

11. An electronic device capable of wireless pairing with another electronic device, the electronic device comprising:
a processor that randomly generates a PIN for wireless connection with another electronic device;
a pairing circuit communicating with the processor, the pairing circuit comprising a coding sub-circuit that converts the randomly generated PIN into acoustical tones; and
a speaker output communicating with the processor and the pairing circuit, the speaker output generating the acoustical tones when it is desired to wirelessly pair the electronic device with another electronic device.

12. An electronic device according to claim 11, wherein the pairing circuit comprises a decoding sub-circuit that receives and decodes acoustical tones generated by another electronic device.

13. An electronic device according to claim 11, wherein the electronic device has no display.

14. An electronic device according to claim 11, wherein the electronic device has no keyboard.

15. An electronic device according to claim 11, wherein pairing is performed according to a communication standard, and wherein the processor is programmed to generate the randomly generated PIN having a length equal to a maximum length permitted by the communication standard.
